(19) United States
(12) Patent Application Publication
(10) Pub. No.: US 2011/0320165 A1
(43) Pub. Date: Dec. 29, 2011

(54) ELECTRONIC PEN SYSTEM, POSITIONAL VARIATION MEASURING DEVICE, DISPLAY METHOD, AND PROGRAM

(76) Inventors: Junichi Miyamoto, Tokyo (JP); Hiroshi Kajitani, Tokyo (JP)

(21) Appl. No.: 13/254,306

(22) PCT Filed: Mar. 4, 2010
(86) PCT No.: PCT/JP2010/053507

§ 371 Date: Sep. 1, 2011

(30) Foreign Application Priority Data
Mar. 6, 2009 (JP) 2009-053213

(51) Int. Cl. G06F 15/00

(52) U.S. Cl. 702/150

(57) ABSTRACT

Disclosed is an electronic pen system wherein re-calibration can be easily carried out when a receiver is re-attached or when the position of the receiver is varied after calibration to adjust the position of the pen with respect to the receiver to the position of the pen on the image projected by a projector or the like. The system comprises a measuring means for measuring the angle of variation from the initial setting of the receiver for measuring the position of the electronic pen to the re-setting of the receiver and the amounts of movement in the horizontal direction and the vertical direction from the initial setting to the re-setting and a display means for reflecting the measured angle of variation and the measured amounts of movement in the horizontal direction and the vertical direction on the trace of the electronic pen after the re-setting.

### TECHNICAL FIELD

The present invention relates to a technology of detecting a position of an electronic pen with respect to a receiver, and displaying a trace of the electronic pen by causing the position on an image displaying the trace of the electronic pen and the position of the electronic pen to correspond to each other.

### BACKGROUND ART

As a rule, there exists an electronic pen system combining the receiver including two ultrasonic receiving units and one infrared receiving unit, and the electronic pen including an infrared transmitting unit and an ultrasonic transmitting unit. Such electronic pen system is capable of acquiring the position of the electronic pen by attaching the detachable receiver to a whiteboard or the like and measuring a distance from the electronic pen to the receiver, overwriting the trace of the electronic pen on a computer image in some cases and moving a mouse cursor by the electronic pen in some cases.

In details, first, marks are projected as the computer image on the whiteboard to which the receiver has been attached with a projector. Next, a calibration is carried out. The calibration is a process with storing the positions on the image of the marks displayed on the board and the positions tapped by the electronic pen on the projected marks. After the calibration, coordinates are calculated by comparing the position of the electronic pen with a specific reference position previously stored, and by using the calculated coordinates the mouse cursor or the like can be moved corresponding to the pen's movement.

When the images are projected by the projector, they might be warped vertically and horizontally. For this, the position of the electronic pen is acquired by displaying nine calibration mark points or so in such a manner that a screen is partitioned, and after the calibration, the coordinates are calculated by use of some mark points of nine mark points, depending upon the position on the screen of the electronic pen.

One example of the method of carrying out the calibration in a simplified manner is described in Patent literature 1. The method of the calibration described in the Patent Literature 1 is a method of attaching light emitting elements to ultrasonic receiving units of the receiver, imaging the light emitting elements and the projected test video patterns from the projector with imaging elements, and acquiring a positional relationship of the light emitting elements and the projected video from the projector, thereby to cause the position of the electronic pen with respect to the receiver and the position thereof on the image to correspond to each other.

### CITATION LIST

### Patent Literature

PTL 1: JP-P2005-128611A

### SUMMARY OF INVENTION

### Technical Problem

The general electronic pen system, however, necessitates carrying out the calibration procedure once again when the position of the receiver is varied after the receiver is attached to the whiteboard and the calibration is carried out.

Further, the technology of the Patent literature 1 necessitates attaching the light emitting elements to the ultrasonic receiving units of the receiver, and in addition, imaging the light emitting elements and the projected test video patterns from the projector with the imaging elements, and grasping a positional relationship of the light emitting elements and the projected video from the projector. This causes an increase in the cost, and complication of the processing because the light emitting elements and the imaging elements are newly required, and in addition, the image information acquired by the imaging elements needs to be processed.

Thereupon, the present invention has been accomplished in consideration of the above-mentioned problems, and an object thereof lies in providing the technology capable of easily carrying out re-calibration when the receiver is reattached, or when the position of the receiver is varied after the calibration for adjusting the position of the electronic pen with respect to the receiver to the position of the pen on the image projected by the projector or the like is carried out.

### Solution to Problem

The present invention for solving the above-mentioned problems is an electronic pen system, which includes a measuring means for measuring an angle of variation from an initial setting of a receiver for measuring a position of an electronic pen to a resetting, and amounts of movement in a horizontal direction and a vertical direction from the initial setting to the resetting, and a displaying means for reflecting the aforementioned measured angle of variation and amounts of movement in the horizontal direction and the vertical direction upon a trace of the electronic pen after the resetting, and displaying the trace of the electronic pen.

The present invention for solving the above-mentioned problems is a positional variation measuring device, which includes a measuring means for measuring an angle of variation from an initial setting of a receiver for measuring a position of an electronic pen to a resetting, and amounts of movement in a horizontal direction and a vertical direction from the initial setting to the resetting.

The present invention for solving the above-mentioned problems is a display method, which is characterized in measuring an angle of variation from an initial setting of a receiver for measuring a position of an electronic pen to a resetting, and amounts of movement in a horizontal direction and a vertical direction from the initial setting to the resetting, and reflecting the aforementioned measured angle of variation and amounts of movement in the horizontal direction and the vertical direction upon a trace of the electronic pen after the resetting to display the trace of the electronic pen.

The present invention for solving the above-mentioned problems is a program of a measuring device, which causes the aforementioned measuring device to execute a process of measuring an angle of variation from an initial setting of a receiver for measuring a position of an electronic pen to a resetting, and amounts of movement in a horizontal direction and a vertical direction from the initial setting to the resetting.

### Advantageous Effect of Invention

The present invention makes it possible to alleviate the work of the resetting when the receiver is reattached or when the position of the receiver is varied.

### BRIEF DESCRIPTION OF DRAWINGS

FIG. 1 is a schematic view for explain the electronic pen system of the present invention.

FIG. 2 is a block diagram of the receiver of a first exemplary embodiment.

FIG. 3 is a view for explain a positional relation between the receiver and the electronic pen.

FIG. 4 is one example of the calibration marks that are employed at the time of the initial setting.

FIG. 5 is one example of the calibration marks that are employed at the time of the resetting.

FIG. 6 is a view for explain variation of the receiver from the initial setting to the resetting.

FIG. 7 is a flowchart for explaining an operation at the time of the initial setting.

FIG. 8 is a flowchart for explaining an operation at the time of the resetting.

FIG. 9 is a block diagram of the receiver of a second exemplary embodiment.

FIG. 10 is a block diagram of the receiver of a third exemplary embodiment.

### DESCRIPTION OF EMBODIMENTS

### First Exemplary Embodiment

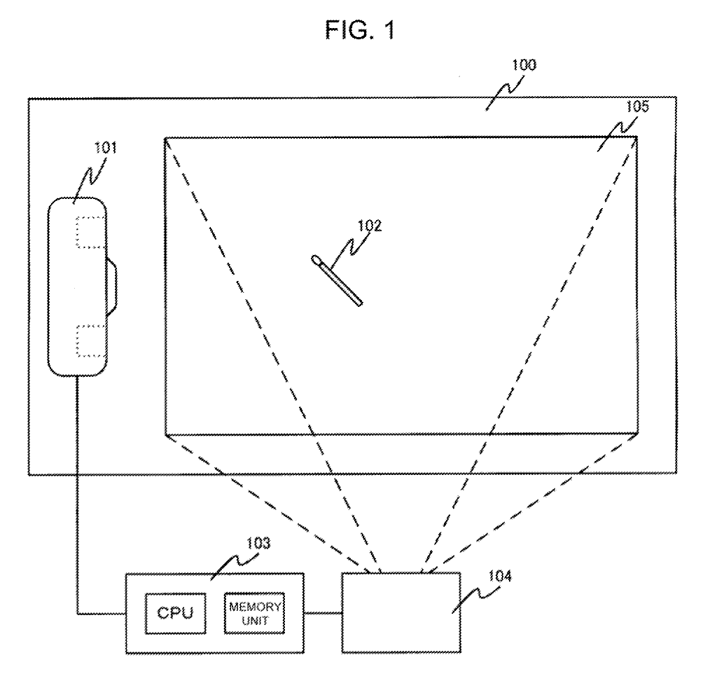

The first exemplary embodiment for carrying out the present invention will be explained in details by making a reference to FIG. 1 to FIG. 6.

FIG. 1 shows one example of the electronic pen system of the present invention. This electronic pen system includes a whiteboard 100, a receiver 101 installed on the whiteboard 100, an electronic pen 102 being used on the whiteboard 100, a computer 103, and a projector 104.

The whiteboard 100 is a projection plane to which the projected images from the projector are thrown on, for example, a whiteboard, a screen and a wall.

Projected images 105 are images outputted from the computer 103 that have been projected upon the whiteboard 100 through the projector 104.

The receiver 101 is a portable receiver. Normally, the receiver 101 is fixed to the whiteboard 100 with magnets, sucking disks, or double-sided adhesive tapes.

The electronic pen 102 is provided with the infrared transmitting unit and the ultrasonic transmitting unit. The electronic pen 102 is configured of a switch that is switched on, synchronized with, for example, a tip of the pen being pressed down due to touching the whiteboard by the electronic pen 102 during the use thereof. The infrared transmitting unit and the ultrasonic transmitting unit simultaneously transmit infrared pulses and ultrasonic pulses, respectively, one time per a constant time period while this switch is ON. Additionally, the constant time period is a value within a range of approximately 15 to 20 ins or so.

The computer 103 outputs data of the projected images 105 such as the images being projected upon the whiteboard 100 and the marks for calibration to the projector 104. Further, the computer 103 calculates positional variation of the receiver by employing the position of the receiver at the time of the setting-up (initial setting) and the position of the receiver at the time of the resetting that is made after the positional variation. The computer performs the processes by employing the calculated positional variation so that the exact trace of the electronic pen is displayed. CPU executes software stored in a memory, thereby allowing the above processes to be performed.

The projector 104 projects data being outputted from the computer 103 on the whiteboard 100.

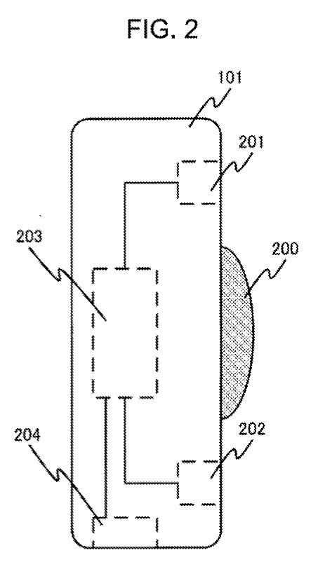

FIG. 2 is a view illustrating a configuration of the receiver 101.

The receiver 101 includes an infrared receiving unit 200, ultrasonic receiving units 201 and 202, a signal processing unit 203, and a communication unit 204.

The infrared receiving unit 200 receives the infrared pulses that are transmitted from the electronic pen 102.

The ultrasonic receiving units 201 and 202 receive the ultrasonic pulses that are transmitted from the electronic pen.

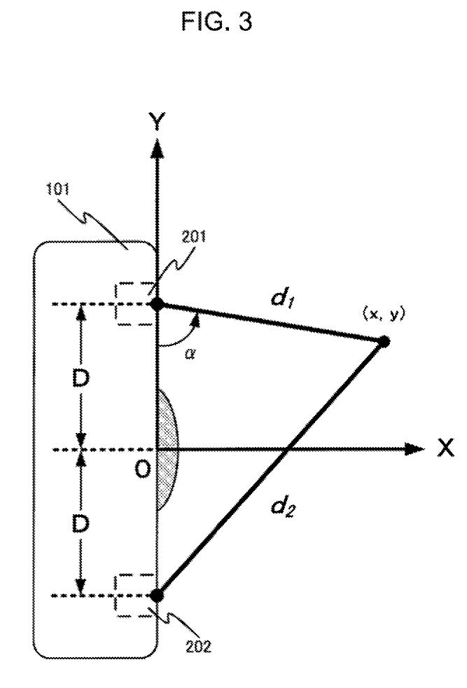

The signal processing unit 203 measures a time that elapses until the ultrasonic receiving units 201 and 202 receive the ultrasonic pulses transmitted from the electronic pen 102 simultaneously with the infrared pulses since the infrared receiving unit 200 has received the infrared pulses transmitted from the electronic pen 102. After the signal processing unit 203 converts the measured time into distances (d1 and d2) with a velocity of sound, it calculates an absolute position (x, y), being the positional coordinates in the horizontal direction/vertical direction of the electronic pen 102 with respect to the receiver 101, by employing a previously-known distance (2×D) between the ultrasonic receiving units and Equation 1.

$${d}_{2}^{2} = {( 2 D )}^{2} + {d}_{1}^{2} - 2 ( 2 D ) {d}_{1} cos α \\ \to {d}_{1} cos α = \frac{{( 2 D )}^{2} + {d}_{1}^{2} + - {d}_{2}^{2}}{4 D} \\ \to y = D - {d}_{1} cos α = \frac{{d}_{2}^{2} - {D}_{1}^{2}}{4 D} \\ x = \sqrt{{d}_{1}^{2} - {( D - y )}^{2}} \qquad [ Equation 1 ]$$

Where the absolute position (x, y) of the electronic pen 102 with respect to the receiver 101, as shown in FIG. 3, is indicative of the positional relation between each of the ultrasonic receiving units 201 and 202 and the position of the pen. The calculated absolute position (x, y) is transmitted via the communication unit 204 to the computer 103.

The communication unit 204, which is connected to the computer 103, transmits information of the absolute position of the electronic pen 102 calculated by the signal processing unit 203 to the computer 103. The connection between the communication unit 204 and the computer 103 is a wire connection by USB via a cable, or a wireless connection such as Bluetooth and a private wireless network.

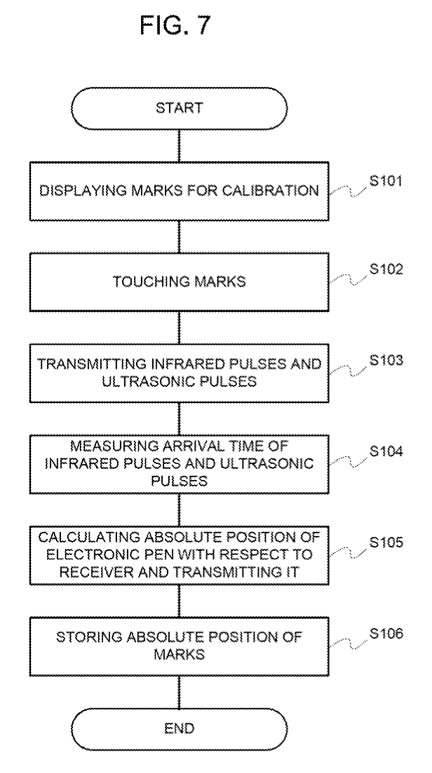

Continuously, an operation of the first exemplary embodiment will be explained. At first, an operation of the calibration for acquiring the positions of the projected images, being a reference, at the moment of displaying the trace of the electronic pen will be explained. FIG. 7 is a flowchart illustrating the operation of the calibration of this exemplary embodiment.

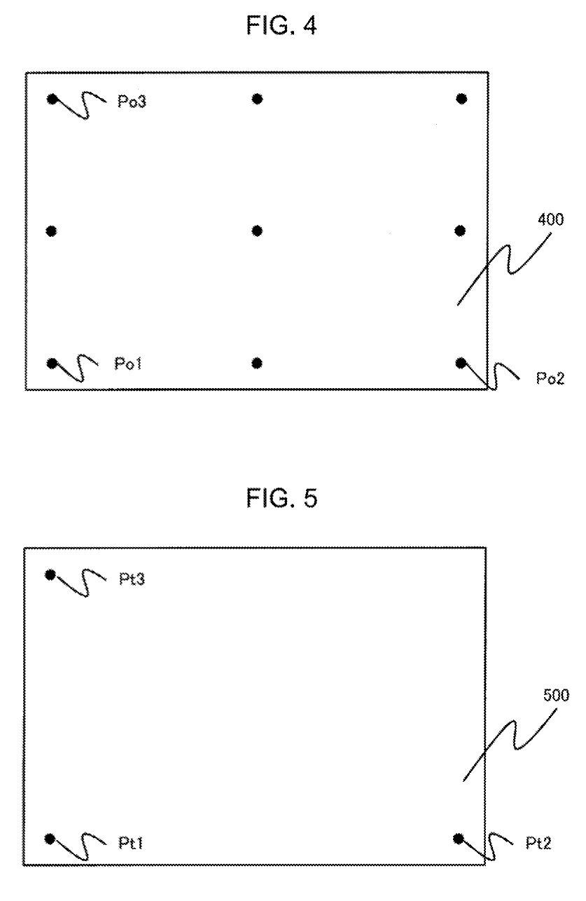

Nine mark points for calibration, as shown in FIG. 4, are projected upon the whiteboard 100 via the projector 104 with the software packed on the computer 103 when the electronic pen system is set-up (step S101). The projected marks 400 in FIG. 4 may be displayed in a lump in some cases, and may be sequentially displayed one point by one point whenever the absolute position of each point is calculated in some cases. In the following, the case of calculating the absolute position of each point by sequentially displaying the marks is employed for explanation. Further, while it was assumed that the number of the marks was nine in this explanation, the number of the marks does not matter so long as the marks are not located in a straight line, and yet the calibration is carried out within an allowable error range.

Any one point of the projected marks 400 is designated by the electronic pen 102. As explained above, when the pen tip of the electronic pen 102 is synchronized with the switch, the marks are touched by the pen tip of the electronic pen 102 (step S102).

When the points of the projected marks 400 are designated by the electronic pen 102, the infrared pulses and the ultrasonic pulses are simultaneously transmitted by the infrared transmitting unit and the ultrasonic transmitting unit from the electronic pen 102, respectively (step S103).

The signal processing unit 203 of the receiver 101 measures a time that elapses until the ultrasonic pulses transmitted from the electronic pen 102 simultaneously with the infrared pulses are inputted into the ultrasonic receiving units 201 and 202 since the infrared pulses transmitted from the electronic pen 102 have been inputted into the infrared receiving unit 200 (step S104). After the signal processing unit 203 converts the measured time into distances with a velocity of sound, it calculates the absolute position (x, y), being the positional coordinates in the horizontal direction/vertical direction of the electronic pen 102 with respect to the receiver 101, by employing the above distances, a previously-known distance (2×D) between the ultrasonic receiving units and Equation 1. And the signal processing unit 203 transmits the calculated position information via the communication unit 204 to the computer 103 (step S105).

The software packed on the computer 103 receives the position information of the electronic pen 102 transmitted from the receiver 101, and causes the memory unit of the computer 103 to store the position information of the electronic pen 102 together with the positions on the computer image displaying the marks for calibration (step S106).

The serial procedures of the step S101 to the step S106 are repeated for each of the nine mark points for calibration, and the calibration procedure at the time of setting up the electronic pen system is finished.

After the calibration is finished, the software packed on the computer 103 overwrites the trace of the electronic pen 102 on the computer image in some case and moves the cursor responding to movement of the electronic pen 102 in some cases by comparing the position of the electronic pen 102 that is transmitted from the receiver 101 during the use of the electronic pen 102 with the position of the electronic pen 102 in the calibration marks previously stored, and converting the position of the electronic pen 102 into the position on the computer image.

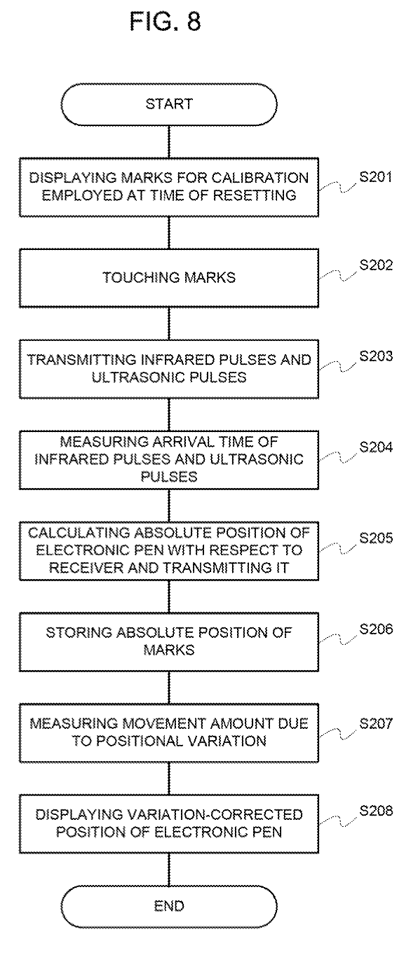

Hereinafter, an operation at the time of the resetting that is made when the receiver 101 on the whiteboard 100 is reattached because of coming off, or when the position of the receiver 101 is varied during the use after setting up the electronic pen system, as described above, will be explained. FIG. 8 is a flowchart of this exemplary embodiment illustrating an operation at the time of the resetting.

At first, with the software packed on the computer 103, three mark points of nine mark points for calibration employed at the time of setting up the electronic pen system, as shown in FIG. 5, are projected upon the whiteboard 100 via the projector 104 (step S201). The projected marks 500 in FIG. 5 may be displayed in a lump in some cases, and may be sequentially displayed one point by one point whenever the process to be described below is performed. With three mark points being displayed, three mark points that are not located in a straight line are selected.

The points of the projected marks 500 are touched by the electronic pen 102 (step S202).

When the points of the projected marks 500 are designated by the electronic pen 102, the infrared pulses and the ultrasonic pulses are simultaneously transmitted by the infrared transmitting unit and the ultrasonic transmitting unit from the electronic pen 102, respectively (step S203).

The signal processing unit 203 of the receiver 101 measures a time that elapses until the ultrasonic pulses transmitted from the electronic pen 102 simultaneously with the infrared pulses are inputted into the ultrasonic receiving units 201 and 202 since the infrared pulses transmitted from the electronic pen 102 have been inputted into the infrared receiving unit 200 (step S204). After the signal processing unit 203 converts the measured time into distances with a velocity of sound, it calculates the absolute position (x, y), being the positional coordinates in the horizontal direction/vertical direction of the electronic pen 102 with respect to the receiver 101, by employing the above distances, a previously-known distance between the ultrasonic receiving units and Equation 1. And the signal processing unit 203 transmits the calculated position information via the communication unit 204 to the computer 103 (step S205).

The software packed on the computer 103 receives the position information of the electronic pen 102 transmitted from the receiver 101, and causes the memory unit of the computer 103 to store the position information of the electronic pen 102 together with the positions on the computer image displaying the marks for calibration (step S206).

The serial procedures of the step S201 to the step S206 are repeated for each of three mark points for calibration, and the amount of variation from the attachment position of the receiver 101 at the time of the setting-up to the attachment position after positional variation of the receiver 101 is measured by employing the positional coordinates of the marks in the locations corresponding to the marks for calibration employed at the time of the resetting and the positional coordinates of the marks for calibration at the time of the resetting, out of the positional coordinates of the marks for calibration at the time of the setting-up (step S207).

The position of the electronic pen 102 is converted into the position on the computer image by employing the position of the electronic pen 102 in the calibration marks previously stored, and the calculated positional coordinates (step S208).

Herein, the details of the measurement of a rotation movement angle θ, being the amount of variation, and a movement amount (a, b) in the horizontal direction (X axis)/the vertical direction (Y axis) will be explained.

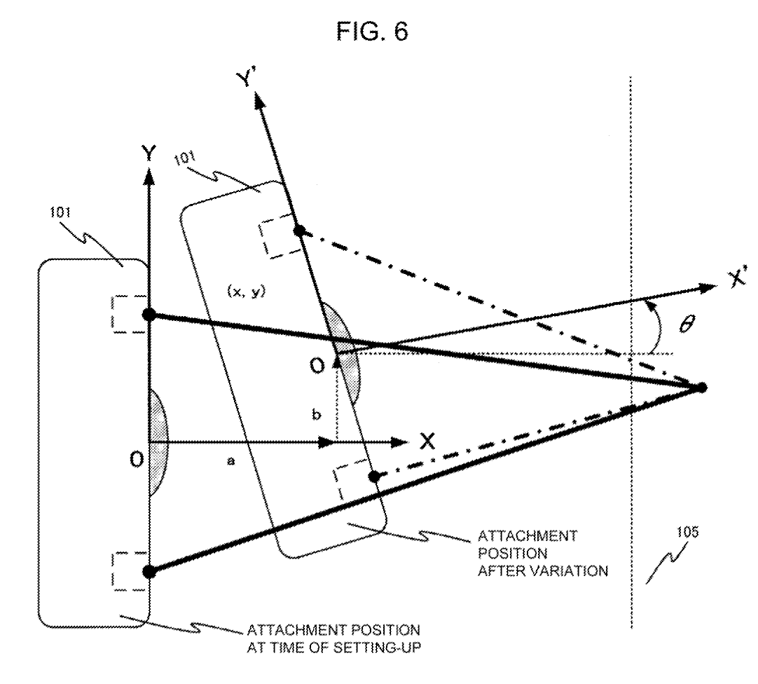

FIG. 6 is a view illustrating a relation between the attachment position of the receiver 101 at the time of setting up the electronic pen system and the attachment position of the receiver 101 at the time of the resetting.

The movement to the attachment position after the variation of the position of the receiver 101 from the attachment position of the receiver 101 at the time of the setting-up is a movement of which the amount in the horizontal direction/the vertical direction, and the rotation movement angle are (a, b) and θ, respectively.

It is assumed that the positional coordinates of the marks in the locations corresponding to the marks for calibration employed at the time of the resetting, out of the positional coordinates of the marks for calibration at the time of the setting-up stored in the computer 103, are Po1(Xo1, Yo1), Po2(Xo2, Yo2), Po3(Xo3, Yo3) (see FIG. 4). On the other hand, it is assumed that the positional coordinates of the marks in the locations corresponding to the marks for calibration employed for confirming the variation are Pt1(Xt1, Yt1), Pt2(Xt2, Yt2), Pt3(Xt3, Yt3) (see FIG. 5). In such a case, a relation of Equation 2 holds.

$$\begin{matrix}( \begin{matrix}X {o}_{1} \\ Y {o}_{1}\end{matrix} ) = ( \begin{matrix}a \\ b\end{matrix} ) + ( \begin{matrix}cos θ & - sin θ \\ sin θ & cos θ\end{matrix} ) ( \begin{matrix}X {t}_{1} \\ Y {t}_{1}\end{matrix} ) \\ ( \begin{matrix}X {o}_{2} \\ Y {o}_{2}\end{matrix} ) = ( \begin{matrix}a \\ b\end{matrix} ) + ( \begin{matrix}cos θ & - sin θ \\ sin θ & cos θ\end{matrix} ) ( \begin{matrix}X {t}_{2} \\ Y {t}_{2}\end{matrix} ) \\ ( \begin{matrix}X {o}_{3} \\ Y {o}_{3}\end{matrix} ) = ( \begin{matrix}a \\ b\end{matrix} ) + ( \begin{matrix}cos θ & - sin θ \\ sin θ & cos θ\end{matrix} ) ( \begin{matrix}X {t}_{3} \\ Y {t}_{3}\end{matrix} )\end{matrix} \qquad [ Equation 2 ]$$

Employing this relation allows matrix A indicative of the rotation movement angle θ to be calculated like Equation 3, and this is stored.

$$\begin{matrix}A = ( \begin{matrix}cos θ & - sin θ \\ sin θ & cos θ\end{matrix} ) \\ = ( \begin{matrix}X {o}_{2} - X {o}_{1} & X {o}_{3} - X {o}_{1} \\ Y {o}_{2} - Y {o}_{1} & Y {o}_{3} - Y {o}_{1}\end{matrix} ) {( \begin{matrix}X {t}_{2} - X {t}_{1} & X {t}_{3} - X {t}_{1} \\ Y {t}_{2} - Y {t}_{1} & Y {t}_{3} - Y {t}_{1}\end{matrix} )}^{- 1}\end{matrix} \qquad [ Equation 3 ]$$

In addition, the movement amount (a, b) in the horizontal direction/the vertical direction is calculated with Equation 4 by employing the calculated matrix A, and is stored.

$$( \begin{matrix}a \\ b\end{matrix} ) = ( \begin{matrix}X {o}_{1} \\ Y {o}_{1}\end{matrix} ) - A ( \begin{matrix}X {t}_{1} \\ Y {t}_{1}\end{matrix} ) \qquad [ Equation 4 ]$$

After the calibration at the time of the resetting is finished, the software packed on the computer 103 calculates the positional coordinates converted into a coordinate system with respect to the position of the receiver at the time of the setting-up from the position of the electronic pen 102 that is transmitted from the receiver 101 during the use of the electronic pen 102, and the stored rotation movement angle θ and movement amount (a, b) in the horizontal direction/the vertical direction by employing Equation 5.

$$( \begin{matrix}X o \\ Y o\end{matrix} ) = ( \begin{matrix}a \\ b\end{matrix} ) + A ( \begin{matrix}X t \\ Y t\end{matrix} ) \qquad [ Equation 5 ]$$

The trace of the electronic pen 102 is overwritten onto the computer image, the cursor is moved responding to the movement of the electronic pen 102, or the like by converting the position of the electronic pen 102 into the position on the computer image by employing the position of the electronic pen 102 in the calibration marks previously stored, and the calculated positional coordinates.

As mentioned above, the calibration method of the present invention makes it possible to alleviate the work in the resetting by employing the three mark points for calibration and making the resetting without carrying out the calibration once again employing the nine mark points for calibration at the time of the resetting that is made after the receiver 101 is reattached.

### Second Exemplary Embodiment

Next, the second exemplary embodiment for carrying out the present invention will be explained. The above-mentioned exemplary embodiment measured the positions of the three mark points for calibration, out of the marks for calibration employed at the time of the setting-up, at the time of the resetting, and calculated the amount of variation. In this exemplary embodiment, a configuration of measuring the amount of variation by measuring the positions of the three mark points, out of the marks for calibration employed at the time of the setting-up, at the time of the resetting, and measuring the rotation movement angle by employing a rotation sensor will be explained. Additionally, a configuration similar to that of the above-mentioned first exemplary embodiment will be explained by employing the identical codes, and a difference with the first exemplary embodiment will be explained with it at a center.

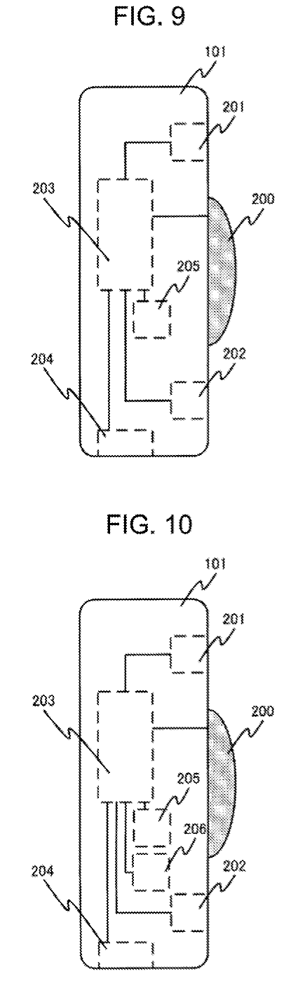

FIG. 9 is a view illustrating a configuration of the receiver 101. The receiver 101 includes the infrared receiving unit 200 for receiving the infrared pulses being transmitted from the electronic pen 102, the ultrasonic receiving units 201 and 202 for receiving the ultrasonic pulses being transmitted from the electronic pen 102 similarly, the signal processing unit 203 for performing a signal process for the received signals, the communication unit 204 connected to the computer 103 that transmits the positional information of the electronic pen 102 calculated by the signal processing unit 203 to the computer 103, and in addition, a rotation sensor 205 located in the center of the receiver 101 that detects the rotation of the receiver 101.

The rotation sensor detects an absolute angle with respect to the vertical direction of the receiver 101.

The signal processing unit 203 measures a time that elapses until the ultrasonic pulses simultaneously transmitted from the electronic pen 102 are inputted into the ultrasonic receiving units 201 and 202 since the infrared pulses transmitted from the electronic pen 102 have been inputted into the infrared receiving unit 200, and calculates the absolute position (x, y), of the electronic pen 102 with respect to the receiver 101. Further, the signal processing unit 203 loads the value of the rotation sensor 205 at that time simultaneously therewith, and transmits the value of the rotation sensor together with the calculated positional information to the computer 103 via the communication unit 204.

Continuously, an operation of the second exemplary embodiment will be explained. Additionally, in the following, the positions of the marks that are employed at the time of the resetting will be explained by employing Pt1 of FIG. 5.

At first, the calibration is carried out at the time of setting up the electronic pen system with nine mark points 400 for calibration similarly to the first exemplary embodiment. At this time, the rotation sensor detects the absolute angle with respect to the vertical direction of the receiver 101. The software packed on the computer 103 receives the position of the electronic pen 102 transmitted from the receiver 101 and the rotation sensor value of the receiver 101, and stores them together with the positions on the computer image displaying the marks for calibration. Additionally, with regard to the rotation sensor value, when the nine rotation sensor values are dispersed, an average value of the nine rotation sensor values may be stored as a representative value.

Next, an operation of the resetting that is made when the receiver 101 on the whiteboard 100 is reattached because of coming off, or when the position of the receiver 101 is varied during the use after setting up the electronic pen system, as described above, will be explained.

At first, one mark point of the nine mark points for calibration employed at the time of setting up the electronic pen system is projected upon the whiteboard 100 via the projector 104 (Pt3 of FIG. 5) with the software packed on the computer 103, and is designated by the electronic pen 102.

When the projected mark is designated by the electronic pen 102, the infrared pulses and the ultrasonic pulses are simultaneously transmitted by the infrared transmitting unit and the ultrasonic transmitting unit, respectively, from the electronic pen 102.

The signal processing unit 203 of the receiver 101 measures a time that elapses until the ultrasonic pulses simultaneously transmitted from the electronic pen 102 are inputted into the ultrasonic receiving units 201 and 202 since the infrared pulses transmitted from the electronic pen 102 have been inputted into the infrared receiving unit 200, and calculates the absolute position (x, y) of the electronic pen 102 with respect to the receiver 101.

Further, the signal processing unit 203 loads the value of the rotation sensor 205 at that time, and transmits the value of the rotation sensor together with the calculated positional information to the computer 103 via the communication unit 204.

The software packed on the computer 103 receives the position (the position of Pt3) of the electronic pen 102 transmitted from the receiver 101 and the rotation sensor value of the receiver 101, and stores them together with the positions on the computer image displaying marks for calibration.

The rotation movement angle θ in FIG. 6 can be calculated from a difference between the rotation sensor value stored at the time of the setting-up and the rotation sensor value stored at the time of the resetting. The rotation sensor value stored at the time of the setting-up is a rotation sensor value corresponding to a point identical to the point of the calibration mark that are displayed at the time of the resetting-up, or a representative value, being an average value of the rotation sensor values at the time of the nine-point measurement.

The rotation movement angle of the receiver 101 in the marks for calibration from the angle at the time of the setting-up to the angle at the time of the resetting is calculated and transmitted to the computer 103.

The amount of variation from the attachment position of the receiver 101 at the time of the setting-up to the attachment position after the variation of the position of the receiver 101 is measured by employing the positional coordinate of the mark (Po3 of FIG. 4) in the location corresponding to the mark for calibration employed at the time of the resetting, and the positional coordinate of the mark (Pt3 of FIG. 5) for calibration at the time of the resetting, out of the positional coordinates of the marks for calibration at the time of the setting-up.

The position of the electronic pen is converted into the position on the computer image by employing the position of the electronic pen 102 in the calibration marks previously stored, and the calculated positional coordinates.

Herein, the details of the measurement of a rotation movement angle θ and the movement amount (a, b) in the horizontal direction/the vertical direction, being the amount of variation, will be explained.

It is assumed that the positional coordinates of the electronic pen 102 and the rotation sensor value of the receiver 101 at the time of the setting-up are Po3 (Xo3, Yo3) and θo3, respectively. On the other hand, it is assumed that the positional coordinates of the electronic pen 102 and the rotation sensor value of the receiver 101 at the time of the resetting are Pt3 (Xt3, Yt3) and θt3, respectively.

In this case, the movement rotation angle θ is an angle that is given by θ=θt3−θo3. When it is assumed that the point of Pt3 rotated by θ is Pt′3(Xt′3, Yt′3), a relation of Equation 6 holds.

$$( \begin{matrix}X {t}_{3}^{′} \\ Y {t}_{3}^{′}\end{matrix} ) = ( \begin{matrix}cos θ & - sin θ \\ sin θ & cos θ\end{matrix} ) ( \begin{matrix}X {t}_{3} \\ Y {t}_{3}\end{matrix} ) \qquad [ Equation 6 ]$$

The amount (a, b) of movement in the horizontal direction/the vertical direction at the time of the resetting becomes a=Xo3−Xt′3, b=Yo3−Yt′3, and the above amount (a, b) of movement in the horizontal direction/the vertical direction and the movement rotation angle θ are stored.

After the calibration at the time of the resetting is finished, the software packed on the computer 103 calculates the positional coordinates converted into a coordinate system with respect to the position of the receiver at the time of the setting-up from the position of the electronic pen 102 that is transmitted from the receiver 101 during the use of the electronic pen 102, and the stored rotation movement angle θ and movement amount (a, b) in the horizontal direction/the vertical direction by employing Equation 7.

$$( \begin{matrix}X o \\ Y o\end{matrix} ) = ( \begin{matrix}a \\ b\end{matrix} ) + ( \begin{matrix}cos θ & - sin θ \\ sin θ & cos θ\end{matrix} ) ( \begin{matrix}X t \\ Y t\end{matrix} ) \qquad [ Equation 7 ]$$

The trace of the electronic pen 102 is overwritten onto the computer image, the cursor is moved responding to the movement of the electronic pen 102, or the like by converting the position of the electronic pen 102 into the position on the computer image by employing the position of the electronic pen 102 in the calibration marks previously stored, and the calculated positional coordinates.

As mentioned above, the calibration method of the present invention can carry out the calibration employing one mark point for calibration at the time of the resetting that is made after the receiver 101 is reattached.

### Third Exemplary Embodiment

Next, an operation of the third exemplary embodiment will be explained. In the above-mentioned second exemplary embodiment, the configuration of measuring the amount of movement by measuring the positions of the three mark points, out of the marks for calibration employed at the time of the setting-up, at the time of the resetting, and measuring the rotation movement angle by employing the rotation sensor was explained. In this exemplary embodiment, a configuration of measuring the amount of movement by employing an acceleration sensor, and measuring the rotation movement angle by employing the rotation sensor will be explained. Additionally, a configuration similar to that of the above-mentioned first exemplary embodiment or second exemplary embodiment will be explained by employing the identical codes, and a difference will be explained with it at a center.

FIG. 10 is a view illustrating a configuration of the receiver 101. The above receiver 101 differs in a point of additionally including an acceleration sensor 206 as compared with that of the above-mentioned second exemplary embodiment.

The acceleration sensor 206 measures acceleration in the horizontal direction/the vertical direction of the receiver 101 at an arbitrary time period. And, the acceleration sensor 206 carries out second-order integration for the measured acceleration, and calculates displacement in each direction.

Continuously, an operation of this exemplary embodiment will be explained.

At first, the receiver carries out the calibration with nine mark points 400 for calibration similarly to the second exemplary embodiment, and measures the rotation sensor value of the receiver 101 at the time of setting up the electronic pen system. And, the software packed on the computer 103 stores them.

Next, an operation of the resetting that is made when the receiver 101 on the whiteboard 100 is reattached because of coming off, or when the position of the receiver 101 is varied during the use after setting up the electronic pen system, as described above, will be explained.

After the setting-up, the signal processing unit 203 accumulates and files the movement amounts (a, b) in the horizontal direction/the vertical direction of the receiver detected by the acceleration sensor 206 during the use of the electronic pen system.

The signal processing unit 203 calculates and files the rotation movement angle θ similarly to the above-mentioned second exemplary embodiment at the time of the resetting.

After the resetting is finished, the software packed on the computer 103 calculates the positional coordinates converted into a coordinate system with respect to the position of the receiver at the time of the setting-up from the position of the electronic pen 102 that is transmitted from the receiver 101 during the use of the electronic pen 102, and the stored rotation movement angle θ and movement amount (a, b) in the horizontal direction/the vertical direction by employing Equation 7.

The trace of the electronic pen 102 is overwritten onto the computer image, the cursor is moved responding to the movement of the electronic pen 102, or the like by converting the position of the electronic pen 102 into the position on the computer image by employing the position of the electronic pen 102 in the calibration marks previously stored, and the calculated positional coordinates.

As mentioned above, the calibration method of the present invention makes it possible to overwrite the trace of the electronic pen 102 onto the computer image, and to move the cursor by the movement of the electronic pen 102 without afflicting electronic pen users with labor and time at the time of the resetting that is made after the receiver 101 is reattached.

(Supplementary note 1) An electronic pen system, including:

a measuring means for measuring an angle of variation from an initial setting of a receiver for measuring a position of an electronic pen to a resetting, and amounts of movement in a horizontal direction and a vertical direction from the initial setting to the resetting; and

a displaying means for reflecting the aforementioned measured angle of variation and amounts of movement in the horizontal direction and the vertical direction upon a trace of the electronic pen after the resetting, and displaying the trace of the electronic pen.

(Supplementary note 2) The electronic pen system according to Supplementary note 1, wherein the aforementioned measuring means includes a means for calculating the aforementioned angle of variation from the initial setting of the receiver to the resetting and amounts of movement in the horizontal direction and the vertical direction from the initial setting to the resetting from positions of basic points with respect to the receiver projected at the time of the initial setting, and the positions of at least three basic points with respect to the aforementioned receiver, out of the aforementioned basic points projected at the time of the resetting.

(Supplementary note 3) The electronic pen system according to Supplementary note 1, wherein the aforementioned measuring means includes:

a means for calculating the amounts of movement in the horizontal direction and the vertical direction from the positions of the basic points with respect to the receiver projected at the time of the initial setting, and the position of at least one basic point with respect to the aforementioned receiver, out of the aforementioned basic points projected at the time of the resetting; and

a rotation sensor for measuring the aforementioned angle of deviation from the initial setting to the resetting of the receiver.

(Supplementary note 4) The electronic pen system according to Supplementary note 1, wherein the aforementioned measuring means includes:

an acceleration sensor for measuring the amounts of movement in the horizontal direction and the vertical direction from the initial setting to the resetting; and

a rotation sensor for measuring an angle of deviation from the initial setting to the resetting of the aforementioned receiver.

(Supplementary note 5) A positional variation measuring device, including a measuring means for measuring an angle of variation from an initial setting of a receiver for measuring a position of an electronic pen to a resetting, and amounts of movement in a horizontal direction and a vertical direction from the initial setting to the resetting.

(Supplementary note 6) A display method, characterized in:

measuring an angle of variation from an initial setting of a receiver for measuring a position of an electronic pen to a resetting, and amounts of movement in a horizontal direction and a vertical direction from the initial setting to the resetting; and

reflecting the aforementioned measured angle of variation and amounts of movement in the horizontal direction and the vertical direction upon a trace of the electronic pen after the resetting, and displaying the trace of the electronic pen.

(Supplementary note 7) The display method according to Supplementary note 6, characterized in calculating the aforementioned angle of variation from the initial setting of the receiver to the resetting and amounts of movement in the horizontal direction and the vertical direction from the initial setting to the resetting from positions of basic points with respect to the receiver projected at the time of the initial setting, and the positions of at least three basic points with respect to the aforementioned receiver, out of the aforementioned basic points projected at the time of the resetting.

(Supplementary note 8) The display method according to Supplementary note 6, characterized in:

calculating the amounts of movement in the horizontal direction and the vertical direction from the positions of the basic points with respect to the receiver projected at the time of the initial setting, and the position of at least one basic point with respect to the aforementioned receiver, out of the aforementioned basic points projected at the time of the resetting; and

measuring the aforementioned angle of deviation from the initial setting to the resetting of the receiver by employing a rotation sensor.

(Supplementary note 9) The display method according to Supplementary note 6, characterized in:

measuring the amounts of movement in the horizontal direction and the vertical direction from the initial setting to the resetting by employing an acceleration sensor; and

measuring the aforementioned angle of deviation from the initial setting to the resetting of the receiver by employing a rotation sensor.

(Supplementary note 10) A program of a measuring device, causing the aforementioned measuring device to execute a process of measuring an angle of variation from an initial setting of a receiver for measuring a position of an electronic pen to a resetting, and amounts of movement in a horizontal direCtion and a vertical direction from the initial setting to the resetting.

### REFERENCE SIGNS LIST

100 whiteboard
101 receiver
102 electronic pen
103 computer
104 projector
200 infrared receiving unit
201 and 202 ultrasonic receiving units
203 signal processing unit
205 rotation sensor
206 acceleration sensor

1. An electronic pen system, comprising:
a measuring means for measuring an angle of variation from an initial setting of a receiver for measuring a position of an electronic pen to a resetting, and amounts of movement in a horizontal direction and a vertical direction from the initial setting to the resetting; and
a displaying means for reflecting said measured angle of variation and amounts of movement in the horizontal direction and the vertical direction upon a trace of the electronic pen after the resetting, and displaying the trace of the electronic pen.

2. An electronic pen system according to claim 1, wherein said measuring means comprises a means for calculating said angle of variation from the initial setting of the receiver to the resetting and amounts of movement in the horizontal direction and the vertical direction from the initial setting to the resetting from positions of basic points with respect to the receiver projected at the time of the initial setting, and the positions of at least three basic points with respect to said receiver, out of said basic points projected at the time of the resetting.

3. An electronic pen system according to claim 1, wherein said measuring means comprises:
a means for calculating the amounts of movement in the horizontal direction and the vertical direction from the positions of the basic points with respect to the receiver projected at the time of the initial setting, and the position of at least one basic point with respect to said receiver, out of said basic points projected at the time of the resetting; and
a rotation sensor for measuring said angle of deviation from the initial setting to the resetting of the receiver.

4. An electronic pen system according to claim 1, wherein said measuring means comprises:
an acceleration sensor for measuring the amounts of movement in the horizontal direction and the vertical direction from the initial setting to the resetting; and
a rotation sensor for measuring said angle of deviation from the initial setting to the resetting of the receiver.

5. A positional variation measuring device, comprising a measuring means for measuring an angle of variation from an initial setting of a receiver for measuring a position of an electronic pen to a resetting, and amounts of movement in a horizontal direction and a vertical direction from the initial setting to the resetting.

6. A display method, comprising:
measuring an angle of variation from an initial setting of a receiver for measuring a position of an electronic pen to a resetting, and amounts of movement in a horizontal direction and a vertical direction from the initial setting to the resetting; and
reflecting said measured angle of variation and amounts of movement in the horizontal direction and the vertical direction upon a trace of the electronic pen after the resetting, and displaying the trace of the electronic pen.

7. A display method according to claim 6, comprising calculating said angle of variation from the initial setting of the receiver to the resetting and amounts of movement in the horizontal direction and the vertical direction from the initial setting to the resetting from positions of basic points with respect to the receiver projected at the time of the initial setting, and the positions of at least three basic points with respect to said receiver, out of said basic points projected at the time of the resetting.

8. A display method according to claim 6, comprising:
calculating the amounts of movement in the horizontal direction and the vertical direction from the positions of the basic points with respect to the receiver projected at the time of the initial setting, and the position of at least one basic point with respect to said receiver, out of said basic points projected at the time of the resetting; and
measuring said angle of deviation from the initial setting to the resetting of the receiver by employing a rotation sensor.

9. A display method according to claim 6, comprising:
measuring the amounts of movement in the horizontal direction and the vertical direction from the initial setting to the resetting by employing an acceleration sensor; and
measuring said angle of deviation from the initial setting to the resetting of the receiver by employing a rotation sensor.

10. A program of a measuring device, causing said measuring device to execute a process of measuring an angle of variation from an initial setting of a receiver for measuring a position of an electronic pen to a resetting, and amounts of movement in a horizontal direction and a vertical direction from the initial setting to the resetting.
